(19) United States
(12) Patent Application Publication
(10) Pub. No.: US 2016/0279891 A1
(43) Pub. Date: Sep. 29, 2016

(54) MOLD DEVICE

(71) Applicant: KOBAYASHI INDUSTRY CO., LTD., Akita (JP)

(72) Inventor: Kiyomitsu Itou, Akita (JP)

(73) Assignee: Kobayashi Industry Co., Ltd., Akita (JP)

(21) Appl. No.: 14/898,610

(22) PCT Filed: Jun. 24, 2015
(86) PCT No.: PCT/JP2015/068201

§ 371 Date: Apr. 26, 2016

(30) Foreign Application Priority Data
Aug. 28, 2014 (JP) 2014-174245

(51) Int. Cl. B30B 7/04; B30B 11/02

(52) U.S. Cl. CPC B30B 7/04; B30B 11/027

(57) ABSTRACT

Provided is a mold device which forms a cavity of a predetermined shape, even if timing of reaching a predetermined position for forming the cavity is different among dies, due to a difference in advancing speed among the dies.

A die segment 3a butts against a pair of die segments 3b and 3c at a first parting surface 4 and a second parting surface 5, respectively. In the first parting surface 4, a longitudinally protruding part 6 which is locally protruding is formed, and thereby a first guide surface 9 which extends parallel to a travel direction of the die segment 3b is formed. In the second parting surface 5 of the die segment 3b, a longitudinally recessed part 7 which is locally recessed is formed, and thereby a second guide surface 10 which butts against the first guide surface 9 of the die segment 3a is formed.

### TECHNICAL FIELD

The present invention relates to a mold device which is used for powder molding of metal, ceramics, etc.

### BACKGROUND ART

Conventionally, as a mold device used for powder molding of metal, ceramics, etc., a device composed of a die having a cavity and upper and lower punches inserted from above and below into the cavity is used. With this mold device, powder molding is performed by filling powder of metal, ceramics, etc. into the cavity of the die and compressing this powder by the punches inserted into the cavity of the die from above and below the die.

Here, depending on the shape of a powder compact to be formed, the die may be divided into three or more parts. The divided dies each have parting surfaces extending along a moving direction of the punch, and can advance and retract in a direction in which the cavity is formed.

When the die is divided into three parts, for example, the dies advance respectively from three directions toward the cavity, and each die butts against adjacent dies at the parting surfaces, so that the mold is closed and the cavity is formed (e.g., see Patent Literature 1).

### CITATION LIST

### Patent Literature

Patent Literature 1: Japanese Patent Laid-Open No. H10-94899

### SUMMARY OF INVENTION

### Technical Problem

If the die is divided as described above, it is necessary to ensure that the cavity has a desired shape when the respective dies are butted against one another to form the cavity. A slider which drives the dies is divided into one main slider and two sub-sliders, and positioning of the respective dies is performed by first driving the main slider to a predetermined position and then driving the sub-sliders until the parting surfaces of the respective dies butt against one another (see Patent Literature 1).

In the conventional device, however, if there is a difference in the speed of advancing the sub-sliders toward the cavity, the die which is coupled with a faster one of the sub-sliders first butts against the die coupled with the main slider. Here, since the parting surfaces of the respective dies are inclined surfaces, the sub-sliders may fail to stop at the butting position and slide over the inclined surface, being pushed further forward.

Thus, if a die moved by one of the sub-sliders is displaced, another die moved by the slower one of the sub-sliders is also displaced, so that the cavity may be formed inaccurately.

Even when the sliders and the dies are adapted so as to be guided by a guide member in only an advancing/retracting direction, slippage between the dies may occur due to the inclination of the parting surfaces, which may result in distortion of the cavity.

An object of the present invention is to eliminate the above inconveniences and provide a mold device which can reliably forma cavity of a predetermined shape, even if timing of reaching a predetermined position for forming the cavity is different among dies, as in a case where there is a difference in advancing speed among the dies.

### Solution to Problem

The present invention relates to a mold device comprising: a plurality of die segments configured to be able to advance and retract along separate guide tracks; and an upper punch and a lower punch to be inserted from above and below, respectively, into a cavity formed by the plurality of die segments, the cavity being formed, while the plurality of die segments are respectively located at specified positions, by each butting against one die segment and the other die segment of a pair of die segments of the plurality of die segments at a first parting surface and a second parting surface, respectively.

In the mold device of the present invention, in the first parting surface of at least one die segment of the plurality of die segments, a longitudinally protruding part which is locally protruding toward the one die segment is formed, and thereby a first guide surface is formed which extends parallel to a travel direction of the one die segment in a top view, and, in the second parting surface, which butts against the first pasting surface of the at least one die segment, of the one die segment, a longitudinally recessed part which is locally recessed so as to correspond to the longitudinally protruding part of the at least one die segment is formed, and thereby a second guide surface is formed which butts against the first guide surface formed in the first parting surface of the at least one die segment located at the specified position and which extends parallel to the travel direction of the one die segment.

According to the mold device of the present invention, a state may arise where at least one die segment (first die segment) has advanced and reached its specified position while one die segment (second die segment) of a pair of die segments to butt against the first die segment has not yet reached its specified position. In this state, the first guide surface formed in the first parting surface of the first die segment and the second guide surface formed in the second parting surface of the second die segment can be butted against each other. Thus, while advance of the first die segment along the guide track beyond its specified position is restricted, the second die segment is allowed to advance along the guide track with its second guide surface kept in sliding contact with the first guide surface of the first die segment. Then, when the second die segment has reached its specified position, the second parting surface of the second die segment is entirely butted against the first parting surface of the first die segment, so that advance of the second die segment beyond this specified position is restricted.

Therefore, when the die segments are advanced toward the specified positions, even if the timing of reaching the specified position is different among the die segments to butt against one another, the position of each die segment is reliably controlled to its specified position, so that the control accuracy of the cavity shape is improved.

Here, being parallel to the travel direction of a die segment means being substantially parallel thereto, and also means being parallel within a range of angles at which no slippage etc. occurs even when the die segment is pushed further upon the longitudinally protruding part of the die segment butting into the longitudinally recessed part of an adjacent die segment.

In the mold device of the present invention, it is preferable that the first guide surface is formed in the first parting surface of the other the segment as the at least one die segment, and that the second guide surface, which butts against the first guide surface formed in the first parting surface of the other die segment located at the specified position and which is parallel to a travel direction of the at least one die segment, is formed in the second parting surface of the at least one die segment as the one die segment.

According to the mold device of this configuration, a state may arise where one die segment (third die segment) of a pair of die segments to butt against at least one die segment (first die segment) has advanced and reached its specified position while the first die segment has not yet reached its specified position. In this state, the first guide surface formed in the first parting surface of the third die segment and the second guide surface formed in the second parting surface of the first die segment can be butted against each other. Thus, while advance of the third die segment along the guide track beyond its specified position is restricted, the first die segment is allowed to advance along the guide track with its second guide surface kept in sliding contact with the first guide surface of the third die segment. Then, when the first die segment has reached its specified position, the second parting surface of the first die segment is entirely butted against the first parting surface of the third die segment, so that advance of the first die segment beyond this specified position is restricted.

Therefore, when the respective die segments are advanced toward the specified positions, even if the timing of reaching the specified position is different among the die segments to butt against one another, in particular, even if the order in which the first, second, and third die segments of the plurality of die segments reach the specified positions is uncertain, the position of each die segment is reliably controlled to its specified position, so that the control accuracy of the cavity shape is improved.

In the mold device of the present invention, it is preferable that a laterally protruding part or a laterally recessed part Which is protruding toward or recessed from the one die segment in a side view is formed in the first parting surface of the at least one die segment, and a laterally recessed part or a laterally protruding part which is recessed or protruding so as to correspond to the laterally protruding part or the laterally recessed part formed in the first parting surface of the at least one die segment in a side view, is formed in the second parting surface of the one die segment; and, alternatively or additionally, that a laterally protruding part or a laterally recessed part which is protruding toward or recessed from the other die segment in a side view is formed in the second parting surface of the at least one die segment, and a laterally recessed part or a laterally protruding part which is recessed or protruding so as to correspond to the laterally protruding part or the laterally recessed part formed in the second parting surface of the at least one die segment in a side view is formed in the first parting surface of the other die segment.

According to the mold device of this configuration, when the first parting surface of one die segment and the second parting surface of another die segment are butted against each other, the laterally protruding part (or the laterally recessed part) formed in the first parting surface and the laterally recessed part (or the laterally protruding part) formed in the second parting surface can be engaged with each other. Thus, when the plurality of die segments are located at their respective specified positions to form the cavity, relative displacement in the upper-lower direction of the one die segment and the other die segment is reliably prevented.

### BRIEF DESCRIPTION OF DRAWINGS

FIG. 1 is a perspective view of a major part of a mold device as a first embodiment of the present invention.

FIG. 2 is a top view of the major part of the mold device as the first embodiment of the present invention.

FIG. 3 is a side view of die segments viewed from the direction of the arrow A in FIG. 1.

FIG. 4 is a top view of a major part of a mold device as a second embodiment of the present invention.

FIG. 5 is a top view of a major part of a mold device as a third embodiment of the present invention,

FIG. 6 is a top view of a major part of a mold device as a fourth embodiment of the present invention.

### DESCRIPTION OF EMBODIMENTS

### First Embodiment

### Configuration

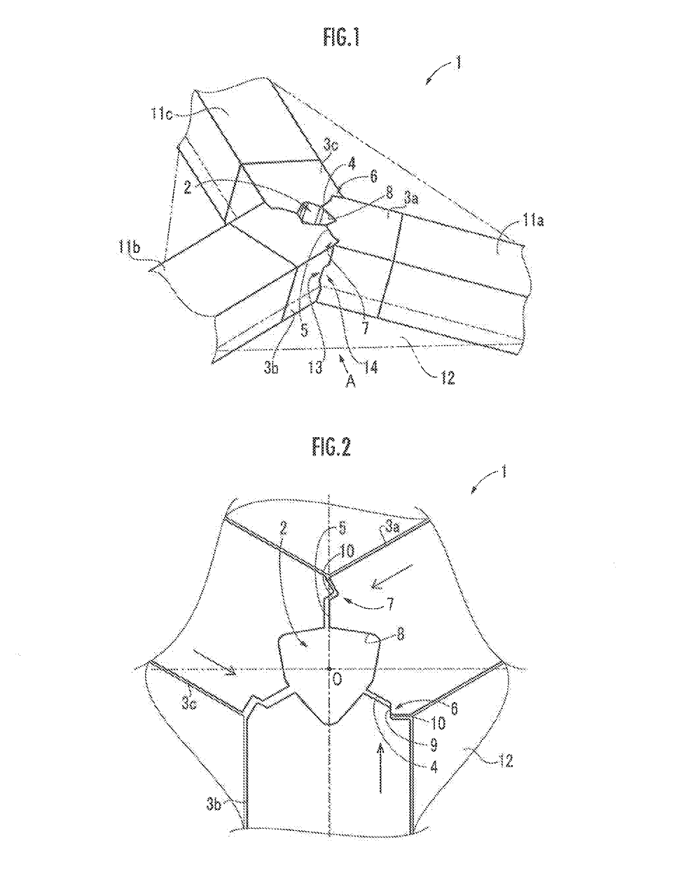

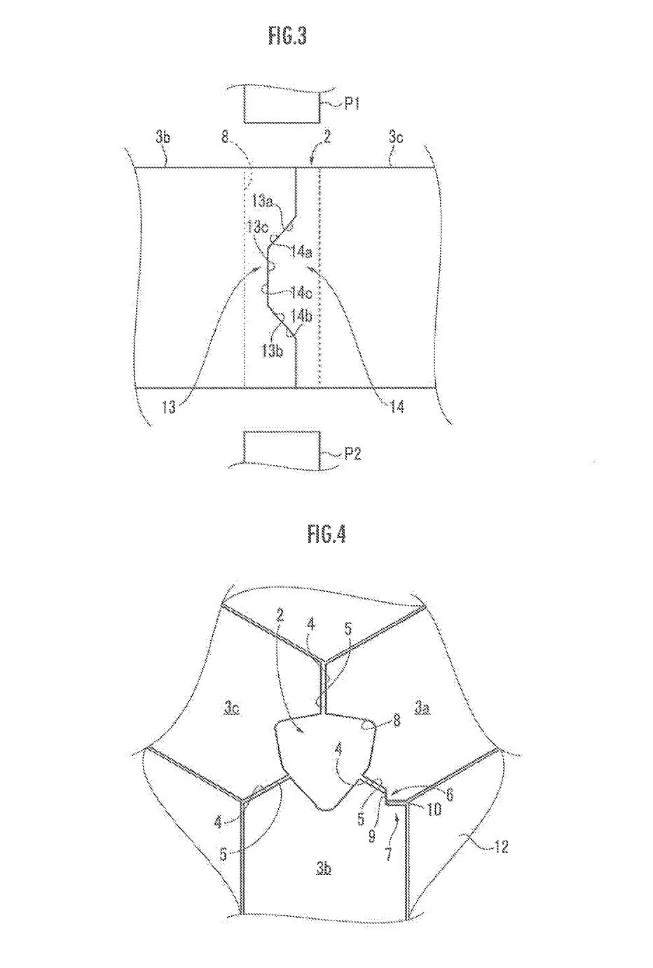

As shown in FIG. 1, a mold device 1 as a first embodiment of the present invention comprises three die segments 3a, 3b, and 3c which butt against or contact one another to form a cavity 2. The mold device 1 further comprises an upper punch P1 and a lower punch P2 which are inserted from above and below into the cavity 2 (see FIG. 3). To simplify the representation of “a”, “b”, and “c” respectively, the signs “i”, “i+”, and “i−” will be used. The sign “i+” means “b” when i=a, “c” when i=b, and “a” when i=c. The sign “i−” means “c” when i=a, “a” when i=b, and “b,” when i=c.

The die segment 3i comprises a first parting surface 4 and a second parting surface 5 which extend along a moving direction or a thickness direction, respectively of the punches P1 and P2 and butt against adjacent die segments 3i+ and 3i−, respectively. In the first parting surface 4 of the die segment 3i, a longitudinally protruding part 6 is formed which is locally protruding in an advancing direction (see the arrow of FIG. 2) of this die segment 3i. In the second parting surface 5 of the die segment 3i, a longitudinally recessed part 7 is formed which is locally recessed in a retracting direction of this die segment 3i.

The longitudinally recessed part 7 of the die segment 3i is shaped so as to match the longitudinally protruding part 6 of the adjacent die segment 3i+ and to fit with the longitudinally protruding part 6 when the mold is closed. The die segment 3i further comprises a cavity forming surface 8 which is recessed, in a shape corresponding to the shape of the cavity 2 (here, in a substantially triangular shape), in the retracting direction between the first parting surface 4 and the second parting surface 5. In the mold device 1, each die segment 3i is driven to advance and retract by each slider 11i coupled with a driving device (not shown).

As shown in FIG. 1 and FIG. 2, movement of the die segment 3i and the slider 11i in a width direction (or a direction perpendicular to the advancing direction and the retracting direction, as well as to the respective moving direction of the punches P1 and P2) is limited by a guide member 12. The die segment 3i and the slider 11i are configured so as to be allow to advance and retract only along a guide track which is determined by the guide member 12. The guide member 12 may be provided along the entire both side surfaces of the die segment 3i and the slider 11i, or may be adapted to guide only a part of the die segment 3i and the slider 11i.

As shown in FIG. 2, central axes extending in the respective travel directions of the three die segments 3a, 3b, and 3c intersect with one another at a center O of the cavity 2. The three die segments 3a, 3b, and 3c are disposed such that the travel directions of respective die segments form angles of 120°, and are configured to be able to advance and retract relative to the center O.

In the longitudinally protruding part 6 of the first parting surface 4 of the die segment 3i, a first guide surface 9 is formed which extends substantially parallel to the travel directions of each of the adjacent other die segments 3i+ and 3i−. The longitudinally recessed part 7 of the die segment 3i is shaped so as to match the longitudinally protruding part 6 of each of the other pair of die segments 3i+ and 3i−. In the longitudinally recessed part 7 of the second parting surface 5 of the die segment 3i, a second guide surface 10 is formed which extends substantially parallel to the travel direction of this die segment 3i and butts against the first guide surface 9 of the adjacent another die segment 3i−.

As shown in FIG. 3, a laterally recessed part 13 which is recessed in a substantially isosceles trapezoidal shape in a side view is formed in the first parting surface 4 of the die segment 3i (in FIG. 3, i=b). The die segment 3i comprises, at the leading end in a side view a non-inclined surface 13c corresponding to the upper base (short base side) of this trapezoid, other than two inclined surfaces 13a and 13b corresponding to the two legs of the trapezoid. That is, the inclined surfaces 13a and 13b of the die segment 3i extend obliquely upward and obliquely downward, respectively, toward the adjacent die segment 3i+.

On the other hand, a laterally protruding part 14 which is protruding in a substantially isosceles trapezoidal shape is formed in the second parting surface 5 of the die segment 3i+ (in FIG. 3, i+=c). The die segment 3i+ comprises, at the leading end in a side view, a non-inclined surface 14c corresponding to the upper base (short base side) of this trapezoid, other than two inclined surfaces 14a and 14b corresponding to the two legs of the trapezoid. The inclined surfaces 14a and 14b and the non-inclined surface 14c of the die segment 3i+ correspond respectively to the inclined surfaces 13a and 13b and the non-inclined surface 13c of the die segment 3i. That is, the inclined surfaces 14a and 14b of the die segment 3i+ extend obliquely downward and obliquely upward, respectively, toward the adjacent die segment 3i.

### Function

When forming the cavity 2 in the mold device 1, first, from an open state of the mold, each die segment 3i is advanced toward the center O of the cavity 2 along the guide track. Here, the timings of reaching the specified positions for forming the cavity 2 do not always match with one another, for a reason such as that there is a difference in advancing speed among the die segments 3a, 3b, and 3c, or that the advancing speeds are equal but the initial positions are shifted.

For example, in a state where the first die segment 3i (e.g., i=a) has advanced and reached its specified position while the second die segment 3i+ and the third die segment 3i− have not yet reached their respective specified positions, the first guide surface 9 formed in the first parting surface 4 of the first die segment 3i and the second guide surface 10 formed in the second parting surface 5 of the second die segment 3i+ can be butted against each other. Thus, while advance of the first die segment 3i along the guide track beyond its specified position is restricted, the second die segment 3i+ is allowed to advance along the guide track with its second guide surface 10 kept in sliding contact with the first guide surface 9 of the first die segment 3i. Moreover, when the second die segment 3i+ has reached its specified position, the second parting surface 5 (including a second main parting surface which is the portion other than the longitudinally recessed part 7) of the second die segment 3i+ is butted against the first parting surface 4 (including a first main parting surface which is the portion other than the longitudinally protruding part 6) of the first die segment 3i, so that advance of the second die segment 3i+ beyond this specified position is restricted. Then, when the third die segment 3i− has reached its specified position, the first parting surface 4 and the second parting surface 5 of the third die segment 3i− butt against the second parting surface 5 of the first die segment 3i and the first parting surface 4 of the second die segment 3i+, respectively, so that advance of the third die segment 3i− beyond its specified position is restricted.

Therefore, when the die segments 3a, 3b, and 3c are advanced toward their respective specified positions, even if the timing of reaching the specified position is different among the die segments 3a, 3b, and 3c to butt against one another, the position of each die segment 3i is reliably controlled to its specified position, so that the cavity 2 of a specified shape is reliably formed.

As shown in FIG. 3, when butting the first parting surface 4 of one die segment 3i and the second parting surface 5 of another die segment 3i+ against each other, the laterally recessed part 13 formed in the first parting surface 4 and the laterally protruding part 14 formed in the second parting surface 5 can be engaged with each other. Thus, relative displacement in the upper-lower direction of the one die segment 3i and the other die segment 3i+ is also prevented.

### Second Embodiment

In a mold device 1 as a second embodiment of the present invention, formation of the first guide surface and the second guide surface may be omitted in a part of the die segments 3a, 3b, and 3c. For example, as shown in FIG. 4, formation of the applicable guide surface may be omitted in each of the second parting surface 5 of the first die segment 3i (in FIG. 4, i=a) and the first parting surface 4 of the third die segment 3i−, and the second parting surface 5 of the third die segment 3i− and the first parting surface 4 of the second die segment 3i+.

According to the mold device 1 of this configuration, the third die segment 3i− is advanced toward the specified position after the first die segment 3i and the second die segment 3i+ are restricted to their respective specified positions, with the first guide surface 9 and the second guide surface 10 in sliding contact with each other as described above. Then, the third die segment 3i− butts against the second die segment 3i+ at the first parting surface 4, and also butts against the first die segment 3i at the second parting surface 5, so that advance of the third die segment 3i− beyond its specified position is restricted. Thus, the control accuracy of the shape of the cavity 2 is improved.

In the mold device 1 of the second embodiment, the applicable guide surface may be formed in each of the second parting surface 5 of the first die segment 3i and the first parting surface 4 of the third die segment 3i−. Similarly, the applicable guide surface may be formed in each of the second parting surface 5 of the third die segment 3i− and the first parting surface 4 of the second die segment 3i+.

### Third Embodiment

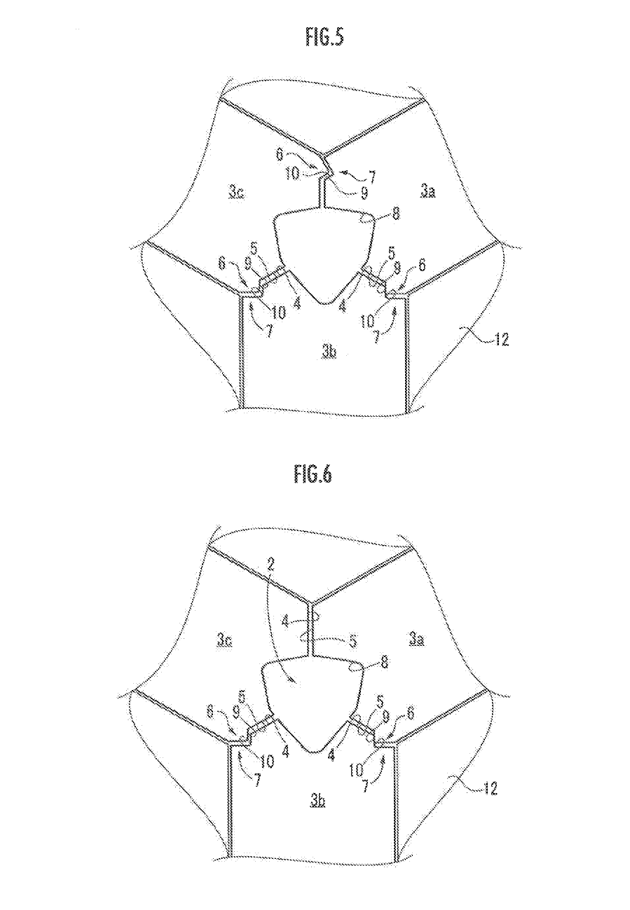

In a mold device 1 as a third embodiment of the present invention, the same guide surfaces (the first guide surface 9 or the second guide surface 10) may be formed in both of the first palling surface 4 and the second parting surface 5 of a part of the die segments 3a, 3b, and 3c. For example, as shown in FIG. 5, the first die segment 3i (in FIG. 5, i=a) may have the first guide surface 9 formed in the first parting surface 4 and the second guide surface 10 formed in the second parting surface 5, while the second die segment 3i+ (in FIG. 5, i+=b) may have the second guide surface 10, originating from the longitudinally recessed part 7, formed in each of the first parting surface 4 and the second parting surface 5, and the third die segment 3i− (in FIG. 5, i−=c) may have the first guide surface 9, originating from the longitudinally protruding part 6, formed in each of the first parting surface 4 and the second parting surface 5.

In the mold device 1 of the third embodiment, the applicable guide surface may be omitted in each of the second parting surface 5 of the first die segment 3i and the first parting surface 4 of the third die segment 3i−. Similarly, the applicable guide surface may be omitted in each of the second parting surface 5 of the third die segment 3i− and the first parting surface 4 of the second die segment 3i+.

### Fourth Embodiment

In a mold device 1 as a fourth embodiment of the present invention, formation of the first guide surface and the second guide surface may be omitted in a part of the die segments 3a, 3b, and 3c as in the second embodiment, and the same guide surfaces may be formed in both of the first parting surface 4 and the second parting surface 5 of a part of the die segments 3a, 3b, and 3c as in the third embodiment. For example, as shown in FIG. 6, formation of the applicable guide surface may be omitted in each of the second parting surface 5 of the first die segment 3i (in FIG. 6, i=a) and the first parting surface 4 of the third die segment 3i− (in FIG. 6, i−=c). In addition, the first guide surface 9 originating from the longitudinally protruding part 6 may be formed in each of the first parting surface 4 of the first die segment 3i and the second parting surface 5 of the third die segment 3i−, and the second guide surface 10 originating from the longitudinally recessed part 7 may be formed in each of the first parting surface 4 and the second parting surface 5 of the second die segment 3i+ (in FIG. 6, i+=b).

While the longitudinally protruding part 6 is formed in a substantially triangular shape in a top view in the first parting surface 4 of the die segment 3i in the above-described embodiment, this longitudinally protruding part 6 may be formed in another shape such as a trapezoidal shape in a top view, as long as it has the first guide surface 9 which is parallel to the travel direction of another die segment 3i+ having the second parting surface 5 to butt against the first parting surface 4 of the die segment 3i.

In the above-described embodiment, the die segment 3i has the laterally recessed part 13 formed in the first parting surface 4 and the laterally protruding part 14 formed in the second parting surface 5 (see FIG. 3). In another embodiment, the die segment 3i may have the laterally protruding part 14 formed in the first parting surface 4 and the laterally recessed part 13 formed in the second parting surface 5. The laterally recessed part 13 and the laterally protruding part 14 in a side view of the die segment 3i may be formed in a shape other than a trapezoidal shape, such as a triangular shape, a semi-circular shape, or a semi-elliptical shape.

While the mold device 1 of the above-described embodiment is configured such that the cavity 2 is formed by the three die segments 3a, 3b, and 3c, a mold device of another embodiment may be configured such that a cavity of a predetermined shape is formed by four or more die segments.

### REFERENCE SIGNS LIST

1 Mold device
2 Cavity
3a, 3b, 3c Die segment
4 First parting surface
5 Second parting surface
6 Longitudinally protruding part
7 Longitudinally recessed part
9 First guide surface (a surface parallel to the travel direction of an adjacent die segment)
10 Second guide surface
13 Laterally recessed part
14 Laterally protruding part

1. A mold device comprising:
a plurality of die segments configured to be able to advance and retract along separate guide tracks; and
an upper punch and a lower punch to be inserted from above and below, respectively, into a cavity formed by the plurality of die segments,
the cavity being formed, while the plurality of die segments are respectively located at specified positions, by each butting against one die segment and the other die segment of a pair of die segments of the plurality of die segments at a first parting surface and a second parting surface, respectively, wherein
in the first parting surface of at least one die segment of the plurality of die segments, a longitudinally protruding part which is locally protruding toward the one die segment is formed, and thereby a first guide surface is formed which extends parallel to a travel direction of the one die segment in a top view, and
in the second parting surface, which butts against the first parting surface of the at least one die segment, of the one die segment, a longitudinally recessed part which is locally recessed so as to correspond to the longitudinally protruding part of the at least one die segment is formed, and thereby a second guide surface is formed which butts against the first guide surface formed in the first parting surface of the at least one die segment located at the specified position and which extends parallel to the travel direction of the one die segment.

2. The mold device according to claim 1, wherein
the first guide surface is formed in the first parting surface of the other die segment as the at least one die segment, and
the second guide surface, which butts against the first guide surface formed in the first parting surface of the other die segment located at the specified position and which is parallel to a travel direction of the at least one die segment, is formed in the second parting surface of the at least one die segment as the one die segment.

3. The mold device according to claim 1, wherein
a laterally protruding part or a laterally recessed part which is protruding toward or recessed from the one die segment in a side view is formed in the first parting surface of the at least one die segment, and a laterally recessed part or a laterally protruding part which is recessed or protruding so as to correspond to the laterally protruding part or the laterally recessed part formed in the first palling surface of the at least one die segment in a side view, is formed in the second parting surface of the one die segment, and, alternatively or additionally,
a laterally protruding part or a laterally recessed part which is protruding toward or recessed from the other the segment in a side view, is formed in the second parting surface of the at least one die segment, and a laterally recessed part or a laterally protruding part which is recessed or protruding so as to correspond to the laterally protruding part or the laterally recessed part formed in the second parting surface of the at least one die segment in a side view, is formed in the first parting surface of the other die segment.
